(19) United States
(12) Patent Application Publication
(10) Pub. No.: US 2023/0318115 A1
(43) Pub. Date: Oct. 5, 2023

(54) LITHIUM-ION BATTERY MODULE STRAP ASSEMBLY

(71) Applicant: STEWART & STEVENSON LLC, Houston, TX (US)

(72) Inventors: Mike WARHUS, Cedar Park, TX (US); Ryan LOOFS, Cedar Park, TX (US); Mike BECK, Cedar Park, TX (US); Tyler KIEFER, Cedar Park, TX (US)

(21) Appl. No.: 18/129,960

(22) Filed: Apr. 3, 2023

Related U.S. Application Data
(60) Provisional application No. 63/327,522, filed on Apr. 5, 2022.

(51) Int. Cl. H01M 50/264; H01M 50/293; H01M 10/0525; H01M 50/224; H01M 50/229; H01M 50/209

(52) U.S. Cl. CPC H01M 50/264; H01M 10/0525; H01M 50/209; H01M 50/224; H01M 50/229; H01M 50/293

(57) ABSTRACT

An assembly includes a cell stack, the cell stack including a plurality of cells, the cells separated by cell spacers. The assembly also includes a compression pad at each end of the cell stack and a lithium-ion battery module strap assembly, the cell stack and compression pads positioned within the lithium-ion battery module strap assembly. The lithium-ion battery module strap assembly includes a case, the case including a bottom and two sides, end caps at each end of the case, and at least one strap, the strap positioned around the cell stack and connected to each end cap.

### CROSS REFERENCE TO RELATED APPLICATIONS

This application is a nonprovisional application which claims priority from U.S. provisional application No. 63/327,522, filed Apr. 5, 2022, which is incorporated by reference herein in its entirety.

### TECHNICAL FIELD/FIELD OF THE DISCLOSURE

The present disclosure relates generally to energy storage, and specifically an improvement to the manufacturing of the lithium-ion battery module assembly and for controlling expansion of a lithium-ion battery module.

### BACKGROUND OF THE DISCLOSURE

As lithium-ion batteries age, they may expand due to heating or overheating. Such expansion may affect the operation of the lithium-battery module in which the lithium-ion batteries are contained and surrounding equipment. Traditional battery modules are held together by fasteners or clamps or structural welding.

### SUMMARY

The disclosure includes an assembly. The assembly includes a cell stack, the cell stack including a plurality of cells, the cells separated by cell spacers. The assembly also includes a compression pad at each end of the cell stack and a lithium-ion battery module strap assembly, the cell stack and compression pads positioned within the lithium-ion battery module strap assembly. The lithium-ion battery module strap assembly includes a case, the case including a bottom and two sides, end caps at each end of the case, and at least one strap, the strap positioned around the cell stack and connected to each end cap.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is an exploded view of a portion of the lithium-ion battery module strap assembly consistent with certain embodiments of the present disclosure.

FIG. 2 is a top view of a cell stack consistent with certain embodiments of the present disclosure.

FIG. 3 is an exploded isometric view of cell stack end caps consistent with certain embodiments of the present disclosure.

FIG. 4 is a side view of the casing consistent with certain embodiments of the present disclosure.

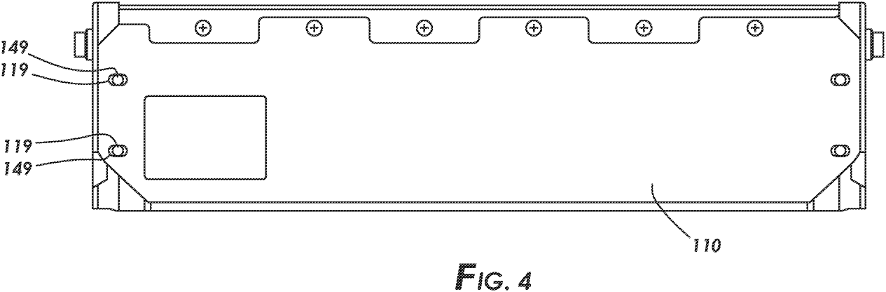

FIG. 5 is an exploded view of a portion of the lithium-ion battery module strap assembly showing the carrier tray.

FIG. 6 is an isometric view of the lithium-ion battery module strap assembly with the straps in place consistent with certain embodiments of the present disclosure.

FIG. 7 is an exploded isometric view of the lithium-ion battery module strap assembly showing rivet installation into the straps.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

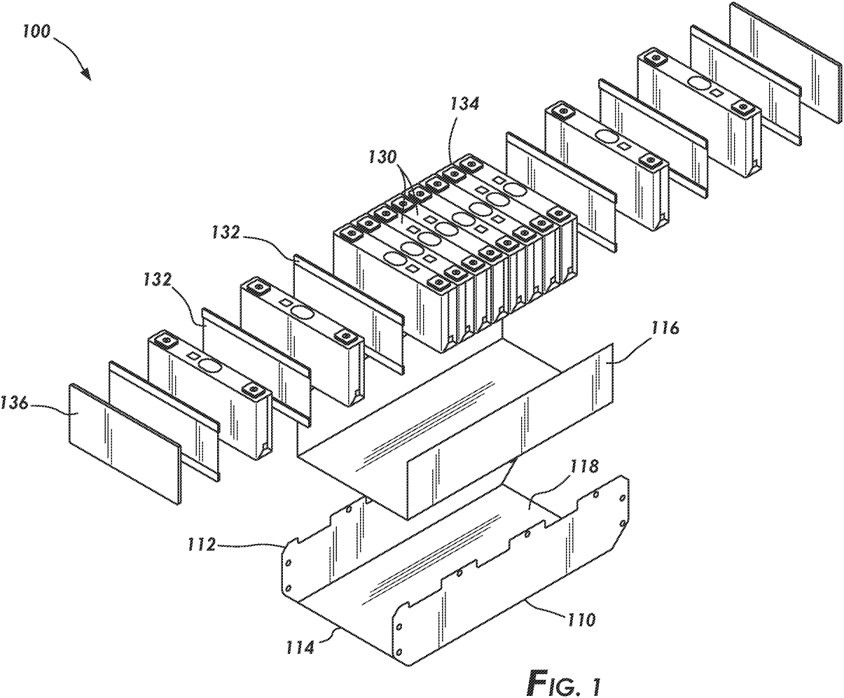

FIG. 1 depicts an exploded view of lithium-ion battery module strap assembly 100 consistent with certain embodiments of the present disclosure. Lithium-ion battery module strap assembly 100 includes case 110. In certain non-limiting embodiments, case 110 is semi-rectangular, although any appropriate shape is contemplated by this disclosure. Case 110 is adapted to maintain the alignment of the lithium-ion cells 130. Sides 112 and bottom 114 of case 110 may be formed of any material that can maintain the alignment of the lithium-ion cells 130, including plastic and metal. In certain embodiments, case 110 is constructed of anodized aluminum. In certain embodiments, case 110 may be insulated by case liner 116. Case liner 116 may be comprised of a polymer, fiberglass or other suitable non-conductive material. A non-limiting example of a material for case liner 116 is Formex GL-17 available from ITW Formex.

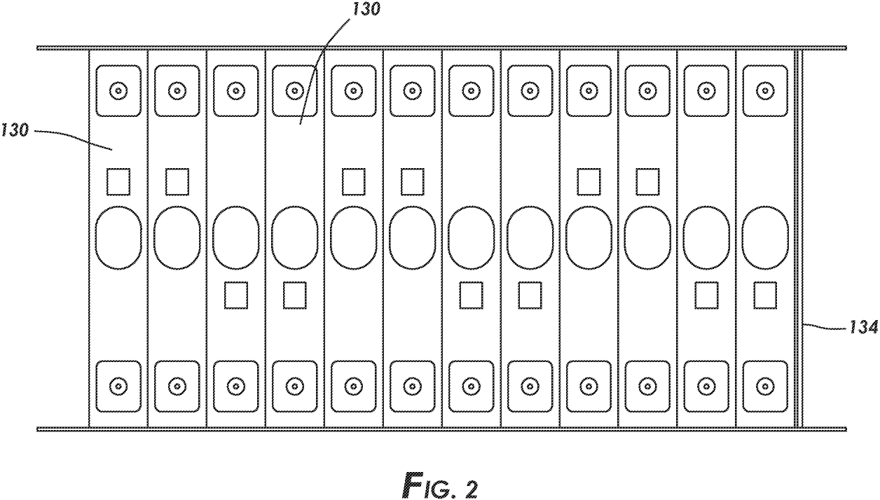

As further shown in FIG. 1, cells 130 may be aligned within case 110. Cells may be, for example, lithium-ion cells. Cells 130 may be separated by cell spacers 132. Cell spacers 132 may perform a number of functions. For example, cell spacers 132 may set the spacing for cells, create a thermal barrier between cells 130, and form an electrically insulated barrier between cells 130. In addition, cell spacers 132 may provide active heating and cooling functions for cells 130. The combination of cells 130 separated by cell spacers 132 may be referred to as cell stack 134. A top view of cell stack 134 is shown in FIG. 2. In certain embodiments, cell spacers 132 are not compressible. At the end of each cell stack 134 are compression pads 136. Compression pads 136 are compressible. A non-limiting example of a material suitable for compression pads 136 is BISCO HT-820 silicone foam available from SRPCO.

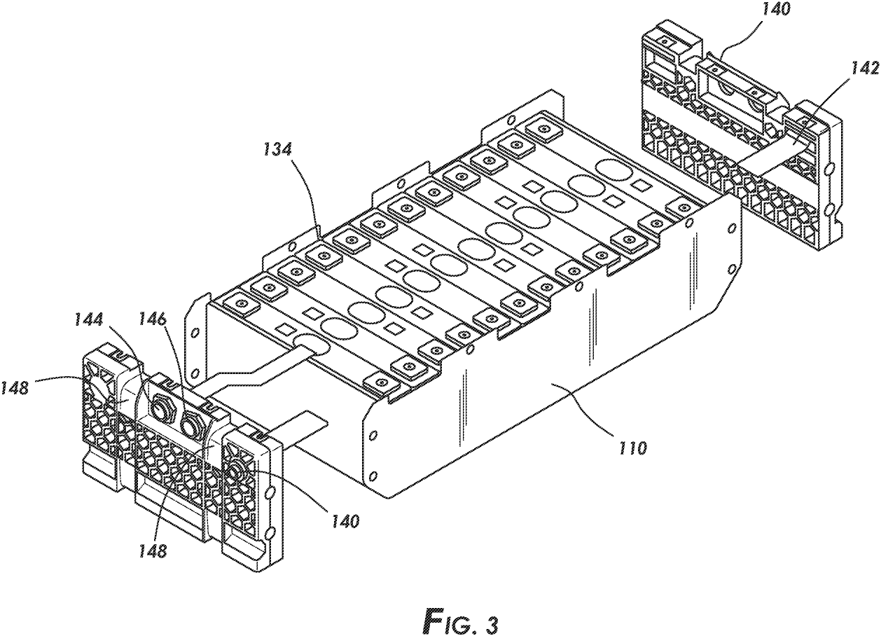

FIG. 3 depicts cell stack 134 with compression pads 136 in place within case 110. Also shown in FIG. 3 are end caps 140. End caps 140 may be constructed with non-conductive plastic or ceramic. In certain embodiments, end caps 140 may be strengthened with a rod constructed of any material that provides adequate reinforcing strength including plastic and metal. End caps 140 are adapted to hold cell stacks 134 under compression during construction of lithium-ion battery module strap assembly 100. As shown in FIG. 3 each end cap 140 includes terminal 142 adapted for electrical connection between cell stack 134 and an external electrical load. By using a non-conductive material for end caps 140, terminals 142 may be integrated into end cap 140. End cap 140 further includes communication ports 144 and 146 for communication between cell stack 134 and an external controller. End caps 140 also include in certain embodiments end cap indents 148. End cap indents 148 are adapted to receive straps 160, described below.

Following positioning of cell stack 134 and compression pads 136 within case 110, end caps 140 may be positioned and used to compress cell stack 134 and compression pads 136, referred to herein as preload compression. In certain embodiments, end caps 140 may compress cell stack 134 and compression pads 136 over a certain distance (D initial) relative to the ends of case 110 with a certain force F low to F high, resulting in over-compression. Over-compression may exceed final compression on cell stack 134 and compression pads 136. In these embodiments, compression pads may be compressed to a preload compression that is greater than the final load compression. In certain embodiments, F high may be 3000 N with F low being 1000 N. In certain embodiments, the over-compression may be performed so that straps 160 may be assembled under no tension after the compressive force is released and a preload tension is maintained. In other embodiments, preload tension may be less than final tension. The compressive force for over-compression may be performed using a tensioning apparatus such as, for example and without limitation, a clamp.

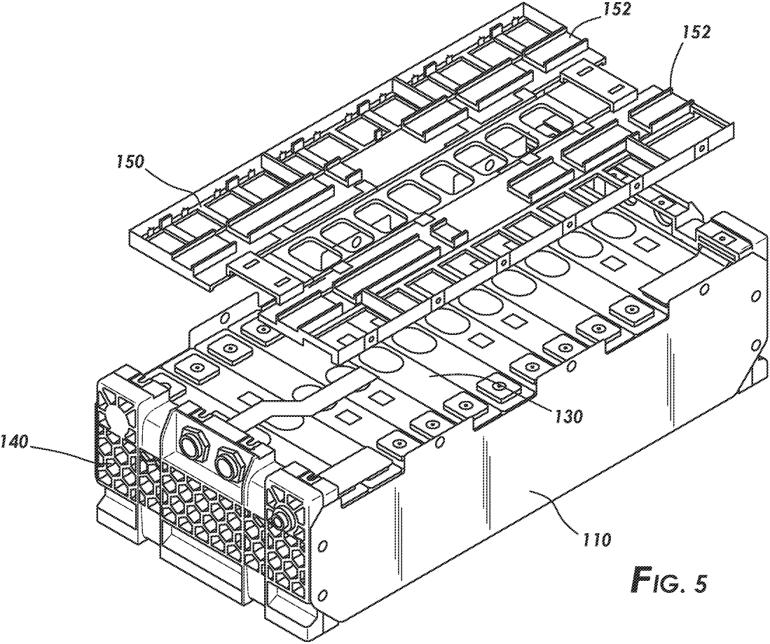

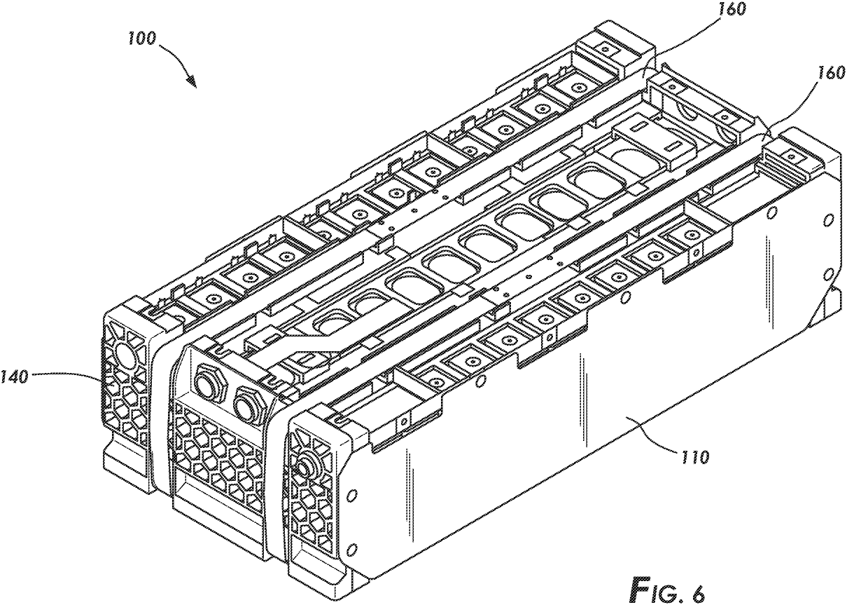

During over-compression, end caps 140 may be slid along surface 118 of case 110 until tabs 149 of end caps 140 engage with tension holes 119 in case 110. Following this step, as shown in FIG. 5, carrier tray 150 may be positioned atop cell stack 134 between sides 112 of case 110 and end caps 140. Carrier tray 150 provides a top to lithium-ion battery module strap assembly 100 and provides strap guides 152 for strap 160. In certain embodiments, carrier tray 150 may be affixed to sides 112 of case 110 by mechanical means such as rivets or screws. In certain embodiments, as shown in FIG. 6, once carrier tray 150 is in place, straps 160 are placed in strap guides 152 and through end cap indents 148. Although two straps are shown, the disclosure contemplates any number of straps necessary to control expansion of lithium-ion cells 130. In certain non-limiting examples, the tensile load applied to each strap 160 from cell expansion may be within the range of 4/n kN to 20/n kN, where “n” is the number of straps to which the swelling force of the cells is applied. In certain examples, the minimum tensile break strength of the straps 160 may be greater than or equal to 1.25 times the maximum expected load.

In certain non-limiting embodiments straps 160 may be made from material such as tensile steel, stainless steel, or a polymer such as polypropylene or a polyester. Once straps 160 are placed, pre-load tension may be released by release of the clamp, compression pads 136 may be partially or completely uncompressed, and straps 160 may carry the final tension load. Each strap 160 bears a tensile load dependent on the characteristics of lithium-ion cells 130. Lithium-ion battery module strap assembly 100 is defined as the combination of case 110, end caps 140 and straps 160.

A number of different processes may be used for wrapping straps 160 around cell stack 134. Non-limiting examples include melding of polymer straps by compression and simultaneous heating; attaching the strap ends by riveting, using pre-drilled rivet holes; steel strapping sealing, which may be applied with a crimping tool; seamless steel strapping, in which one side of strap 160 is deformed into the other side of strap 160 to connect the sides. Each method may have its advantages. For example, using rivets allows the straps to achieve higher strength than without rivets and uses the same length of strap. Steel strapping may not require pre-forming of the strap. Seamless strapping may not require additional components or a special tool.

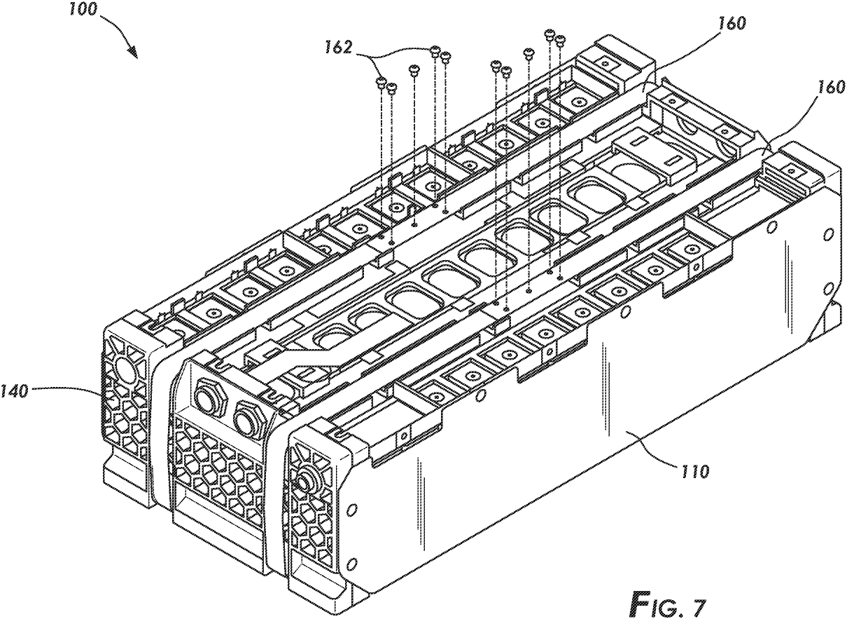

As shown in FIG. 7, in some embodiments, such as when using steel for strap 160, rivets 162 may be placed in strap 160 for additional strength.

In yet other embodiments, such as where lithium-ion cells 130 are pouch cells, a casing, such as an aluminum casing, may be used to contain the cells. The pouch cells may then be placed into cell stack 134.

In certain embodiments, lithium-ion battery module strap assembly 100 keeps lithium-ion batteries at end of life swelling conditions for manageable decommissioning.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. An assembly comprising:
a cell stack, the cell stack including a plurality of cells, the cells separated by cell spacers;
a compression pad at each end of the cell stack;
a lithium-ion battery module strap assembly, the cell stack and compression pads positioned within the lithium-ion battery module strap assembly, the lithium-ion battery module strap assembly comprising:
a case, the case including a bottom and two sides;
end caps at each end of the case; and
at least one strap, the strap positioned around the cell stack and connected to each end cap.

2. The assembly of claim 1, wherein the case is rectangular.

3. The assembly of claim 1, wherein the case is constructed of anodized aluminum.

4. The assembly of claim 1, wherein the case is insulated by a case liner.

5. The assembly of claim 4, wherein the case line is a polymer of fiberglass.

6. The assembly of claim 1, wherein the compression pads are comprised of a silicone foam.

7. The assembly of claim 1, wherein the end caps are constructed of non-conductive plastic or ceramic.

8. The assembly of claim 7, wherein the end caps are strengthened with a rod.

9. The assembly of claim 1, wherein each end cap includes a terminal integrated into the end cap.

10. The assembly of claim 1, wherein each end cap includes an end cap indent adapted to receive the strap.

11. The assembly of claim 1, wherein the assembly further includes a carrier tray, the carrier tray is positioned atop the cell stack and between the sides of the case and the end caps.

12. The assembly of claim 11, wherein the carrier tray includes strap guides.

13. The assembly of claim 1, wherein the strap is made from tensile steel, stainless steel, or a polymer.

14. The assembly of claim 13, wherein the strap is made from a polymer and the polymer is polypropylene or a polyester.

15. The assembly of claim 13, wherein the strap is made from tensile steel or stainless steel and includes rivets.

16. A method comprising:
constructing a cell stack, wherein the cell stack comprises cells separated by cell spacers, the cell stack having two ends;
placing a compression pad on each end of the cell stack;
positioning the cell stack and the compression pads within a case, wherein the case has two sides and a bottom;
positioning end caps within the case;
over-compressing the cell stack and compression pads through the end caps to a preload tension;
placing straps across the cell stack and affixing the straps to the end caps; and
applying a tensile load to the straps that is less than the pre-load tension.

17. The method of claim 16, wherein the force applied to the end caps to achieve the pre-load compression is between 1000N and 3000N.

18. The method of claim 16, wherein the step of over-compressing the cell stack includes sliding the end caps along a surface of the cases and engaging the end caps to the case.

19. The method of claim 16 further comprising positioning the carrier tray atop the cell stack, the carrier tray having strap guides.

20. The method of claim 16 wherein the step of affixing the straps to the end caps comprises melding of the straps by compression and simultaneous heating, wherein the straps are made of a polymer.

21. The method of claim 16 wherein the step of affixing the straps to the end caps comprises attaching the strap ends by riveting, using pre-drilled rivet holes.

22. The method of claim 16 wherein the step of affixing the straps to the end caps comprises steel strapping sealing applied with a crimping tool.

23. The method of claim 16 wherein the step of affixing the straps to the end caps comprises seamless steel strapping, in which a first side of the strap is deformed into a second side of the strap to connect the sides.

24. The method of claim 16 further comprising placing rivets in the strap.
